(19) United States
(12) Patent Application Publication
(10) Pub. No.: US 2003/0079228 A1
(43) Pub. Date: Apr. 24, 2003

(54) Searching for frames to perform a trick mode

(76) Inventors: Shu Lin, Indianapolis, IN (US); Donald Henry Willis, Indianapolis, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/078,877

(22) Filed: Feb. 19, 2002

Related U.S. Application Data
(60) Provisional application No. 60/334,914, filed on Oct. 23, 2001.

(51) Int. Cl. H04N 7/173; H04B 1/66; H04N 7/12; H04N 11/02

(52) U.S. Cl. 725/88; 725/102; 375/240.12; 375/240.25

(57) ABSTRACT

A method (200) or (300) and system (100) of performing a trick mode on a video signal. The method includes the steps of receiving (212) a trick mode command, searching (214) for a picture in the video signal compatible with the trick mode, and initiating (216) the trick mode once the compatible picture is located. The compatible picture can be an intra or a predictive picture. The trick mode can be a freeze trick mode, and the method can further include the step of repeating the compatible picture for the duration of the trick mode to form a trick mode signal. The repeating step can further include the step of repeating the compatible picture for the duration of the trick mode by inserting (218) into the video signal dummy pictures predicted from the compatible picture to form the trick mode video signal. The dummy pictures can be dummy predictive pictures.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

The inventive arrangements relate generally to video systems and more particularly to video systems that record or play back digitally encoded video sequences.

2. Description of Related Art

Digital televisions (DTV) and high-definition televisions (HDTV) are gaining popularity in today's consumer electronics marketplace. Many purchasers of these types of televisions also buy digital video recorders or players, such as a digital video disc (DVD) recorder or player, for purposes of viewing previously recorded programs or recording their favorite programs. Notably, the combination of a DTV (or an HDTV) and a digital video recorder or player can be an integral part of a home theater entertainment system.

A digital video recorder or player typically contains an MPEG decoder to decode the digitally encoded multimedia data that is stored on the discs that the recorder or player plays. If the digital video recorder or player is connected to a conventional (non-DTV or non-HDTV) television, the digitally encoded signal will be decoded by the digital video recorder's or player's MPEG decoder before being displayed on the conventional television. Significantly, however, many DTV's contain their own MPEG decoders, as the MPEG decoder in the majority of digital video recorders or players cannot handle the decoding of video signals for such televisions. As such, if a digital video recorder or player is connected to a DTV, the video signal read from the disc is remotely decoded by the DTV's decoder. This configuration can be referred to as a remote decoder arrangement.

There is, however, an important disadvantage to decoding digitally encoded signals with a remote DTV decoder. Namely, it is very difficult to perform trick modes in this type of arrangement. For example, oftentimes, a trick mode involves repeating a number of pictures in a video signal. As the bandwidth between the digital recorder and the DTV is limited, repeating pictures in the signal being fed to the DTV may cause the signal to exceed the maximum bit rate limit of the transmission channel. The problem is even more acute if the pictures are intra (I) pictures or predictive (P) pictures, as these pictures are generally encoded with more bits than the average picture.

Moreover, certain trick mode commands, such as a freeze or pause command, can be problematic. Namely, when a freeze trick mode is initiated, there is no way to determine exactly how long the trick mode will remain in effect. Consequently, it is impossible to calculate how many times a particular picture will be displayed during this type of trick mode. This uncertainty can interfere with the display order of the pictures being transferred to the decoder in the DTV, as the DTV decoder is not under the control of the digital video recorder and has no way of knowing that a freeze trick mode has been initiated. Thus, a need exists for a method and system for searching for frames to perform a trick mode without increasing system costs or complexity.

SUMMARY OF THE INVENTION

The present invention concerns a method of performing a trick mode on a video signal. The invention includes the steps of: receiving a trick mode command; searching for a picture in the video signal compatible with the trick mode; and initiating the trick mode once the compatible picture is located. In one arrangement, the compatible picture can be an intra picture or a predictive picture.

In another arrangement, the trick mode can be a freeze trick mode, and the method can further include the step of repeating the compatible picture for the duration of the trick mode to form a trick mode signal. Each of the plurality of original pictures can contain a display indicator, and the method can further include the step of selectively modifying the display indicator of the original pictures that follow the compatible picture when the compatible picture is repeated.

In addition, the repeating step can further include the step of repeating the compatible picture for the duration of the trick mode by inserting into the video signal dummy pictures predicted from the compatible picture to form the trick mode video signal. The method can also include the step of selectively modifying the display indicator of the original pictures that follow the compatible picture when a dummy picture is inserted into the video signal. The dummy pictures can be dummy predictive pictures. Further, the compatible picture can be an intra picture, and the method can further include the step of selectively inserting the compatible intra picture into the trick mode signal. At least a portion of the trick mode video signal can be decoded by a remote decoder.

The present invention also concerns a method of performing a trick mode on a video signal including the steps of: receiving a trick mode command; searching for a picture in the video signal compatible with the trick mode; and initiating the trick mode once the compatible picture is located in which the trick mode command is a freeze trick mode.

The invention also concerns a system for performing a trick mode on a video signal. The system includes: a controller for reading data from a storage medium and generating the video signal; and a video processor in which the processor is programmed to: receive a trick mode command; search for a picture in the video signal compatible with the trick mode; and initiate the trick mode once the compatible picture is located. The system also includes suitable software and circuitry to implement the methods as described above.

### BRIEF DESCRIPTION OF THE DRAWINGS

FIG. 1 is a block diagram of a system that can search for frames for purposes of performing a trick mode in accordance with the inventive arrangements herein.

FIG. 2 is a flow chart that illustrates an operation of searching for frames for purposes of performing a trick mode in accordance with the inventive arrangements.

### DETAILED DESCRIPTION OF THE PREFERRED EMBODIMENTS

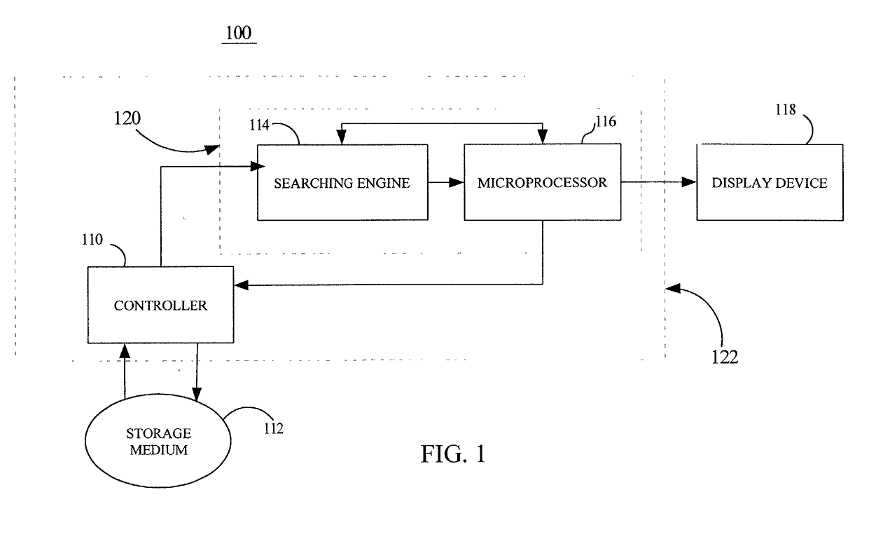

A system 100 for implementing the various advanced operating features in accordance with the inventive arrangements is shown in block diagram form in FIG. 1. The invention, however, is not limited to the particular system illustrated in FIG. 1, as the invention can be practiced with any other system capable of receiving a digitally encoded signal and transferring that signal to a display device. In addition, the system 100 is not limited to reading data from or writing data to any particular type of storage medium, as any storage medium capable of storing digitally encoded data can be used with the system 100.

The system 100 can include a controller 110 for reading data from and writing data to a storage medium 112. The system 100 can also have a searching engine 114, a microprocessor 116 and a display device 118. The searching engine 114 can contain suitable software and circuitry for locating one or more particular types of pictures in a video signal read from the storage medium 112. Control and data interfaces can also be provided for permitting the microprocessor 116 to control the operation of the controller 110 and the searching engine 114. Suitable software or firmware can be provided in memory for the conventional operations performed by the microprocessor 116. Further, program routines can be provided for the microprocessor 116 in accordance with the inventive arrangements.

It should be understood that all or portions of the searching engine 114 and the microprocessor 116 can be a video processor 120 within contemplation of the present invention. Further, all or portions of the controller 110, the searching engine 114 and the microprocessor 116 can be a bitstream source 122 within contemplation of the present invention. In one arrangement, the display device 118 can contain its own decoder (not pictured) for decoding all or a portion of any video signal read from the storage medium 112 and processed by the bitstream source 122. In this particular arrangement, the decoder (not shown) in the bitstream source 122 typically does not decode the video signal read from the storage medium 112. This particular embodiment can be referred to as a remote decoder arrangement, and the decoder in the display device 118 can be referred to as a remote decoder. It should be noted, however, that the invention is not limited to this arrangement, as the invention can be practiced in other suitable systems.

In operation, the controller 110 can read a video signal containing a plurality of digitally encoded pictures from the storage medium 112. These pictures can be referred to as original pictures. In one arrangement, if the microprocessor 116 receives a trick mode command, then the microprocessor 116 can signal the searching engine 114 to begin searching for a picture in the video signal compatible with the trick mode. Once a compatible picture is located, the microprocessor 116 can initiate the trick mode. A compatible picture can be an I picture, a P picture or any other picture that can be used to predict other pictures in a video signal.

In one arrangement, the trick mode can be a freeze or pause trick mode. In accordance with the freeze trick mode command, the microprocessor 116 can repeat the compatible picture for the duration of the freeze trick mode to form a trick mode video signal. Additionally, the microprocessor 116 can repeat the compatible picture by inserting into the video signal dummy pictures predicted from the compatible picture to form the trick mode video signal.

In another arrangement, if the searching engine 114 locates a particular compatible picture, the microprocessor 116 can selectively insert this compatible picture into the trick mode video signal. Moreover, following the cessation of the freeze trick mode, the microprocessor 116 can modify certain portions of information contained within one or more of the original pictures that follow the compatible picture to reflect an intended display order. This modification step can be performed whether the compatible picture is repeated or dummy pictures are inserted in the video signal. The overall operation of the invention will be discussed in greater detail below.

### Searching for Frames to Perform a Trick Mode

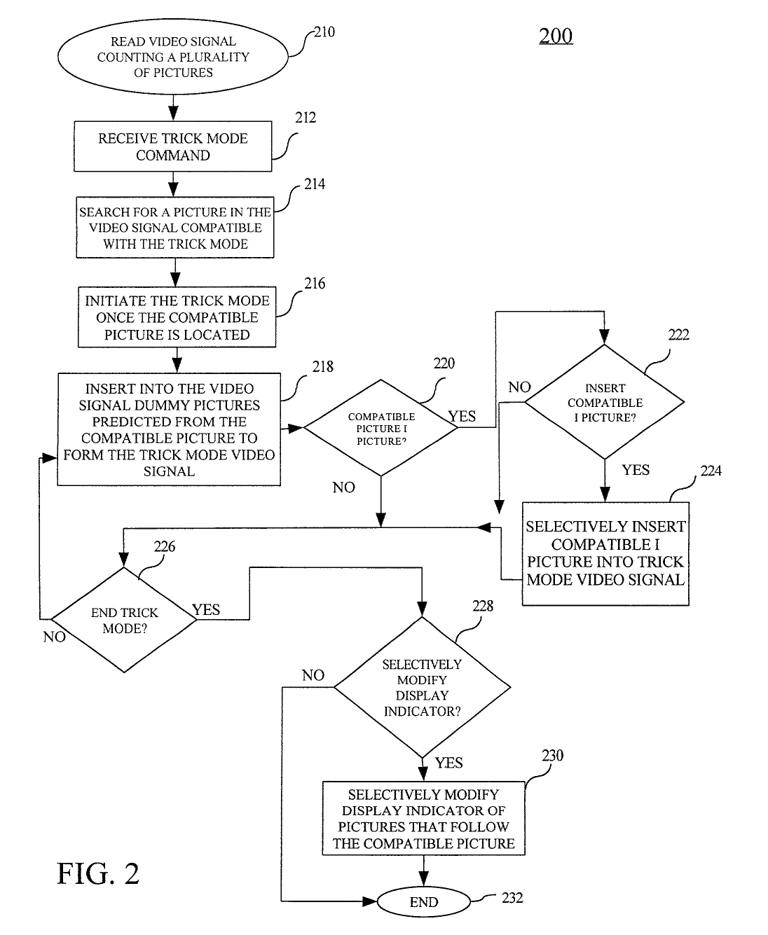

FIG. 2 illustrates a flowchart 200 that demonstrates one way in which searching for frames to perform a trick mode can be executed. In one arrangement, the invention can be practiced in a remote decoder arrangement. For purposes of the invention, a remote decoder arrangement can be any system in which at least a portion of the pictures in a video signal can be decoded by a decoder that is external to and not under the control of a bitstream source that is providing the pictures to the decoder. As an example, the bitstream source can be an optical storage medium player or recorder, such as a digital video player or recorder, that reads multimedia data from an optical storage medium and transfers this data over a transmission channel to a digital television, which contains its own decoder. It is understood, however, that the invention is not limited to this example or even a remote decoder arrangement, as the invention can be practiced in any other suitable system or arrangement.

At step 210, a video signal containing a plurality of original pictures can be read. At step 212, a trick mode command can be received. In one arrangement, the trick mode command can be a freeze or pause trick mode command. For purposes of the invention, a freeze trick mode can be a trick mode in which a particular picture in the video signal can be repeatedly displayed on a display device for an amount of time determined by a viewer. Although the invention is discussed primarily in terms of a freeze trick mode, it must be noted that the invention can be practiced with any other suitable trick mode. Once the trick mode command is received, at step 214, a search of the plurality of original pictures can be conducted to locate a picture compatible with the trick mode. As shown at step 216, the trick mode can be initiated after the compatible picture is located.

As previously mentioned, a compatible picture is a picture in the video signal that can be used to predict other pictures in the video signal. The compatible picture can be repeatedly displayed for the duration of the freeze trick mode to form a freeze trick mode video signal. In one embodiment of the invention, the compatible picture can be an I picture or a P picture. It is understood, however, that the invention is not limited in this regard, as any other suitable picture can be a compatible picture. By delaying the initiation of the freeze trick mode until a compatible picture is located, such as an I or P picture, it is unnecessary to transmit to a decoder a reference or anchor frame that follows the compatible picture to construct the compatible picture prior to the compatible picture being repeated.

As shown at step 218, the repeating the compatible picture step can be performed by inserting into the video signal one or more dummy pictures predicted from the compatible picture to form the freeze trick mode video signal. The dummy pictures can be repeats or duplicates (once they are decoded) of the compatible picture, which can permit the freeze trick mode to be performed. A dummy picture is a picture that can be predicted from certain pictures and whose motion vectors and discrete cosine transform (DCT) coefficients are set to zero (or not encoded). As such, a dummy picture contains very little information. A dummy picture's primary purpose is to duplicate or repeat the picture from which it was predicted using very few bits. Thus, a dummy picture is suitable for replacing the repeated compatible picture when the compatible picture is to be repeated during the freeze trick mode video signal.

The dummy pictures can be transmitted to a remote decoder rather than repeatedly transmitting the compatible picture. This insertion and replacement step may be helpful in keeping a bit rate of the freeze trick mode video signal at a manageable level. Without inserting dummy pictures, repeating the compatible picture may cause the freeze trick mode video signal to exceed a bit rate limit of a transmission channel between a digital video recorder or player and a DTV, particularly if the compatible picture is an I picture or even a P picture. In one arrangement, the dummy pictures can be dummy P pictures. Compared to conventional P pictures, the dummy P pictures contain little encoded information and are suitable for repeating a compatible picture.

At decision block 220, it can be determined whether the compatible picture is an I picture. If the compatible picture is an I picture, at decision block 222, the option of selectively inserting the compatible I picture into the trick mode video signal can be selected and performed at step 224. Occasionally or selectively inserting the compatible picture into the trick mode video signal if it is an I picture can be done merely by repeating the compatible I picture and inserting the compatible I picture among the dummy P pictures in the trick mode video signal. Such a process can enable a decoder, particularly a remote decoder, to continue the decoding of the trick mode video signal if a viewer changes the channel broadcasting the signal and then switches back to this channel. In addition, if the viewer turns off the display device during the freeze trick mode, the insertion of the I pictures permits the decoder to begin decoding the trick mode signal again if the viewer turns the device back on.

As an example, the compatible I picture can be inserted into the trick mode video signal roughly every one-half second to ensure proper decoding in the event that the trick mode video signal is interrupted and its broadcast along a transmission channel is reinitiated. Alternatively, the compatible I picture can be inserted into the trick mode video signal every N number of dummy P pictures, where N can be any suitable number of dummy pictures. As an example, a compatible I picture can be inserted into the trick mode video signal for every fifteen dummy P pictures inserted into the trick mode video signal. It is understood, however, that the invention is not limited to these examples, as other insertion frequencies can be used.

In another arrangement, a sequence header can be inserted into the trick mode video signal each time an I picture is inserted into the signal. The sequence header can assist the decoder during the decoding of the I picture in accordance with the above discussion. The insertion of a GOP header along with each sequence header is another option available to ensure proper decoding of the trick mode video signal. Referring back to flowchart 200, at decision block 226, it can be determined whether the freeze trick mode is to continue. If yes, the flowchart 200 can continue at step 218. If the freeze trick mode is stopped, then the flowchart 200 can continue to decision block 228.

In one arrangement, each of the plurality of original pictures in the video signal can contain a display indicator. A display indicator can instruct certain decoders as to when a particular picture will be displayed relative to a number of other pictures in a video signal. At decision block 228, it can be determined whether certain display indicators are to be selectively modified. If yes, then in one arrangement, the display indicators of original pictures that follow the compatible picture can be selectively modified, as shown at step 230. Notably, modifying these display indicators can reflect an intended display order of the plurality of original pictures if dummy P pictures are inserted in the video signal. Such modification can also occur if compatible I picturess are selectively inserted into the trick mode video signal. If the display indicators are not to be modified, then the flowchart 200 can stop at step 232.

In one arrangement, the display indicator can be a temporal reference field. A temporal reference field is typically a ten bit field located in the picture header of digitally encoded pictures. This field normally has an integer value, which can indicate the order in which a picture is to be displayed. For example, a group of pictures (GOP) generally contains fifteen pictures. The temporal reference field of the first picture in the GOP, i.e., the picture immediately following the GOP header, can have an integer value of zero. The temporal reference field of the next picture to be displayed can have an integer value of one. Thus, the integer value of the temporal reference field for each subsequent picture to be displayed can be increased by one.

When dummy P pictures are inserted into the video signal to form a trick mode video signal (or if the compatible picture is repeated), however, the display order according to the temporal reference fields of the original pictures is no longer valid. Accordingly, the integer value of the temporal reference fields of the original pictures that follow the compatible picture can be modified once the freeze trick mode is completed to indicate a proper display order. Even though the duration of the freeze trick mode is typically unknown, the step of selectively modifying display indicators can readily be performed. This is because the use of compatible pictures, such as an I or P picture, does not require the transfer of a reference picture that follows the compatible picture for purposes of constructing the compatible picture. As such, the display order of all the pictures in the trick mode video signal can be easily determined.

For example, if the first picture in a GOP is a compatible picture such as an I picture, and thirty corresponding dummy P pictures predicted from the compatible picture are inserted into the video signal (roughly a one second freeze), the integer value of the temporal reference field of the compatible picture (assuming that it is the first picture in the GOP to be displayed) can be kept as zero; in addition, the temporal reference field of the first dummy P picture can be set to an integer value of one, the temporal reference field of the second dummy P picture can be set to an integer value of two and the temporal reference field of the third dummy P picture can be set to an integer value of three. Each successive dummy P picture can have a temporal reference field with an integer value that is increased by one over the integer value of the temporal reference field over the previous dummy P picture. Accordingly, the temporal reference field of the final dummy P picture can have an integer value of thirty.

Continuing with the example, once the freeze trick mode is stopped, the integer value of the temporal reference field of the next original picture can be modified to a value of thirty-one to reflect the intended display order. Subsequently, at least a portion of the remaining original pictures that follow the compatible picture can be modified as well. It is understood, however, that the invention is not limited to this example, as freeze trick modes of other temporal lengths can be performed in accordance with the inventive arrangements.

The integer values of the temporal reference fields of the original pictures that follow the compatible picture can also be adjusted in accordance with the above discussion if a compatible I picture is selectively inserted (see step 224) into the trick mode video signal. In addition, the value of the temporal reference field of each selectively inserted I picture can be modified such that this value follows the sequence of the temporal reference field values of the dummy P pictures inserted into the trick mode video signal.

For example, referring back to the example, if the compatible picture is an I picture and is inserted into the trick mode video signal instead of the third dummy P picture, the temporal reference value of the compatible I picture can be modified to a value of three. If this is the only I picture to be inserted into the trick mode signal, then the temporal reference field value of the final dummy P picture can also be thirty. In addition, once the trick mode is stopped, the temporal reference field value of the next original picture can be modified to thirty-one. It must be noted that the invention is not limited to this particular example, as any other number of compatible I picturess can be inserted into the trick mode video signal.

In one arrangement, following the cessation of the freeze trick mode, the step of incrementally increasing the integer values of the temporal reference fields of the original pictures that follow the compatible picture can continue until the temporal reference field of the last picture in the last GOP affected by the trick mode is modified. Once the next GOP is reached, i.e., the next GOP unaffected by the trick mode, the integer value of the temporal reference field of the first display picture in the new GOP can be zero.

In one embodiment of the invention, the integer value for the temporal reference field can have a maximum value of 1,023. If the integer values for the temporal reference fields of the pictures that make up a GOP (the original pictures plus the dummy P pictures and, if applicable, any repeated compatible pictures) reach this value and the trick mode GOP has not ended, then the value of the temporal reference field can merely wrap around and begin again at zero. As an example, if a freeze trick mode involving the insertion of dummy P pictures is initiated and performed for an extended amount of time, the integer value of the dummy P pictures will eventually reach 1,023. Once that occurs, the integer value for the temporal reference field of the next immediate dummy P picture to be displayed can be set to zero. Of course, it should be noted that the invention is not limited to the use of a temporal reference field, as any other suitable display indicator can be modified to reflect an intended display order in either of the embodiments discussed above. Also, the wrap around value is by no means limited to 1,023, as other suitable values can be used. Referring back to the flowchart 200, once the display indicators have been selectively modified, the process can stop at step 232.

Although the present invention has been described in conjunction with the embodiments disclosed herein, it should be understood that the foregoing description is intended to illustrate and not limit the scope of the invention as defined by the claims.

What is claimed is:

1. A method of performing a trick mode on a video signal containing a plurality of original pictures, comprising the steps of:
receiving a trick mode command;
searching the plurality of original pictures in the video signal for a picture compatible with the trick mode; and
initiating the trick mode once the compatible picture is located.

2. The method according to claim 1, wherein the compatible picture is an intra picture.

3. The method according to claim 1, wherein the compatible picture is a predictive picture.

4. The method according to claim 1, wherein the trick mode is a freeze trick mode and said method further comprises the step of repeating the compatible picture for the duration of the trick mode to form a trick mode signal.

5. The method according to claim 4, wherein said repeating step further comprises the step of repeating the compatible picture for the duration of the trick mode by inserting into the video signal dummy pictures predicted from the compatible picture to form the trick mode video signal.

6. The method according to claim 5, wherein each of the plurality of original pictures contains a display indicator and said method further comprises the step of selectively modifying the display indicator of the original pictures that follow the compatible picture when a dummy picture is inserted into the video signal.

7. The method according to claim 6, wherein the dummy pictures are dummy predictive pictures.

8. The method according to claim 7, wherein the compatible picture is an intra picture and said method further comprises the step of selectively inserting the compatible I picture into the trick mode signal.

9. The method according to claim 8, wherein at least a portion of the trick mode is decoded by a remote decoder.

10. A method of performing a trick mode on a video signal, comprising the steps of:
receiving a trick mode command;
searching for a picture in the video signal compatible with the trick mode; and
initiating the trick mode once the compatible picture is located;
wherein the trick mode command is a freeze trick mode.

11. A system for performing a trick mode on a video signal containing a plurality of original pictures, comprising:
a controller for reading data from a storage medium and generating the video signal; and
a video processor, wherein the processor is programmed to:
receive a trick mode command;
search the plurality of original pictures for a picture in the video signal compatible with the trick mode; and
initiate the trick mode once the compatible picture is located.

12. The system according to claim 11, wherein the compatible picture is an intra picture.

13. The system according to claim 11, wherein the compatible picture is a predictive picture.

14. The system according to claim 11, wherein the trick mode is a freeze trick mode and the processor is further programmed to repeat the compatible picture for the duration of the trick mode to form a trick mode signal.

15. The system according to claim 14, wherein the processor is further programmed to repeat the compatible picture for the duration of the trick mode by inserting into the video signal dummy pictures predicted from the compatible picture to form the trick mode video signal.

16. The system according to claim 15, wherein each of the plurality of original pictures contains a display indicator and the processor is further programmed to selectively modify the display indicator of the original pictures that follow the compatible picture when a dummy picture is inserted into the video signal.

17. The system according to claim 16, wherein the dummy pictures are dummy predictive pictures.

18. The system according to claim 17, wherein the compatible picture is an intra picture and the processor is further programmed to selectively insert the compatible I picture into the trick mode signal.

19. The system according to claim 18, further comprising a remote decoder for decoding at least a portion of the trick mode video signal.
